(19) United States
(12) Patent Application Publication
(10) Pub. No.: US 2018/0238111 A1
(43) Pub. Date: Aug. 23, 2018

(54) AN EXTENDABLE WORK PLATFORM

(71) Applicant: Branach Technology Pty Ltd, Boronia (AU)

(72) Inventor: Michael Walsh, Heathmont (AU)

(21) Appl. No.: 15/752,111

(22) PCT Filed: Aug. 12, 2016
(86) PCT No.: PCT/AU2016/050741

§ 371 Date: Feb. 12, 2018

(30) Foreign Application Priority Data
Aug. 14, 2015 (AU) 2015903289

(51) Int. Cl. E06C 1/12

(52) U.S. Cl. CPC E06C 1/12

(57) ABSTRACT

In summary, the invention provides an extendable platform for supporting a user thereon, the platform comprising: an elongate support member; a movable member coupled to the support member to move between a first position and a second position, the moveable member having a step mounted thereto; and an engageable retainer coupled to either of the support member or the moveable member, wherein the movable member is translatable along the support member to vary the position of the step relative to the support member and the retainer couples the support member to the moveable member to retain the step in fixed relationship with the support member.

### TECHNICAL FIELD

This invention relates to an extendable work platform and a method of constructing and adjusting the work platform in situ.

### BACKGROUND

Ladders and extendable platforms have long been used to provide access to elevated work places; however, they pose a serious safety risk and account for numerous injuries worldwide every year to both tradespeople and the general populous.

Typical injuries caused by ladders and extendable work platforms range from slips and falls from people losing their balance whilst on ladders or raised platforms, to destabilising of the ladder/platform when it is placed on an uneven or slippery surface.

Some ladder and platform injuries are caused by people abusing a ladder, for example “walking” the ladder. This occurs when a user mounts the ladder and purposefully destabilises the ladder to lift and twist the legs or stiles of the ladder to avoid having to dismount the ladder to adjust their location. Walking the ladder greatly increases the chances of tipping the ladder by losing grip between the base of the ladder and the supporting surface and further increases the risk of overloading a single stile of the ladder and breaking the stile.

Additional health and safety risks are introduced in the transportation of ladders and extendable platforms and their methods of erection. These risks are inherent in loading a ladder for transportation to a worksite for example loading the ladder onto a truck bed or roof rack of a vehicle, as the larger the ladder the heavier it is. Long ladders and extendable platforms can also exceed the length of the transport vehicle, providing overhanging hazards to both users and road users alike.

Once a ladder or platform is transported to a worksite, the ladder requires positioning and erecting. Some ladders and platforms provide additional sections to increase the length of the ladder. However, once these additional sections are added to a ladder, the ladder becomes even more difficult to control and the greater the risk of injury when raising the ladder into a vertical position, ready for use.

In light of the above, it is always desirable to provide new ladders and extendable platforms or at least address some of the known drawbacks associated therewith.

The term “step” is understood herein to refer to a support for supporting a user thereon and is intended to include rungs, bars, and platforms of various different shapes and sizes.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

### SUMMARY OF THE INVENTION

In accordance with one form of the present invention, there is provided an extendable platform for supporting a user thereon, the platform comprising: an elongate support member; a movable member coupled to the support member to move between a first position and a second position, the moveable member having a step mounted thereto; and an engageable retainer coupled to either of the support member or the moveable member, wherein the movable member is translatable along the support member to vary the position of the step relative to the support member and the retainer couples the support member to the moveable member to retain the step in fixed relationship with the support member.

The support member and movable member in combination provide access to raised work places; however, the individual components of the extendable platform can be restricted to dimensions that provide ease of handling and ease of transportation. Accordingly, the extendable platform can be conveniently transported to a place of use and once in position, the extendable platform is extended to a required working length to facilitate access to the raised work site.

An advantage of the invention is that the individual members of the extendable platform are dimensioned to be easily handled by a single user, both from a dimensional and a weight perspective. This facilitates loading the extendable platform onto a transport vehicle and access through a building to get to the work site.

Using smaller ladder/platform members initially allows ease of erection from a horizontal to vertical position both in overall decreased weight and rotation of the ladder to vertical and being able to avoid obstacles such as tree branches and overhead wires.

To further facilitate transport and set-up of the extendable platform, the movable member and support member are made from a lightweight durable material for example, aluminium or fibreglass. Preferably the extendable platform in its stowed configuration can be lifted by an average size adult.

One embodiment of the invention provides is to use the system to provide a raised platform that constitutes a self-supporting structure whereby a pair of extendable platforms, according to the invention, is used in a back-to-back configuration for receiving movable sections on each side of the structure, allowing a step or platform to be raised to any height. This embodiment essentially provides a variable height platform ladder.

In some embodiments, the extendable platform may comprise an actuator mounted to either of the support member or the movable member. Operation of the actuator may move the moveable member along the elongate support member to vary the position of the step relative to the elongate support member. The actuator may be selectively engageable between the elongate support member and the moveable member.

The retainer may allow relative movement between the support member and the movable member in a first direction and resists movement in a second, opposing direction. The retainer may be a latch.

The retainer provides a safety mechanism that means movable portions of the ladder cannot move relative to the support member when the winch mechanism is disengaged, whether disengagement is accidental or purposeful.

The retainer may be configured to act as a ratchet, such that the retainer allows the movable portions of the extendable platform to extend away from the support member but prevents movement in the opposing direction ie. preventing any movable members from moving back towards the support member.

In some embodiments, the extendable platform may further comprise a removable member having a male coupling at a first end thereof and a female coupling at a second end thereof, wherein the male coupling of the removable member is received by the female coupling of the movable member to thereby couple the removable member to the movable member. Once the support member and moveable member are erected in situ, removable members may be added into the extendable platform for added reach. Each removable member is incorporated with the movable member or an adjacent removable member and also incorporated into the winch mechanism to thereby facilitate further extension of the extendable platform. When each removable member is added to the extendable platform the winch may be disconnected from the movable member and attached to the newly incorporated removable member. As such winch control of the movable member, and any subsequent removable members engaged thereto, is effected from the member directly engaged with the winch: this is typically the lowest of all the moveable members attached to the extendable platform.

In this embodiment, the retainer continues to act as a ratchet, allowing the movable or removable portion of the extendable platform to extend away from the support member but preventing movement in the opposing direction of the movable member, and the removable member from moving back towards the support member.

Removable members may be added repeatedly to extend the platform to a desired working elevation. The portions of the extendable platform may be incorporated with the support member one at a time, as desired.

Each movable and removable member is sized and weighted to be lifted by a single user and safely stowed on a transportation vehicle.

Each of the support member, movable member and removable member may be formed from aluminium, fibreglass, reinforced plastic, composite material or combination thereof. This lightweight and strong configuration of the extendable platform facilitates safe lifting of the extendable platform onto a roof or into a tray of a vehicle for ease of transport.

The individual sections of the extendable platform are easily moveable to be assembled in situ, the entire weight of which does not need to be handled as one weight.

The sizing and therefore structural performance of the sections can be selected individually to customise the stiffness and strength of the overall extendable platform to meet custom performance requirements.

In one embodiment, the actuator may be selectively engageable with the removable member, such that operation of the actuator moves the removable member and the moveable member simultaneously and thereby varies the position of the step relative to the elongate support member.

The actuator may comprise a pair of pulleys and a chord, the chord extending over each of the pulleys to define a continuous loop thereover. The actuator may further comprise a connector permanently attached to the chord.

The connector may be selectively engageable with a cooperating mount on the removable member. The connector may be selectively engageable with at least one of the elongate support member and the moveable member. The connector may be a pin having a releasable detent. The cooperating mount may be an aperture for receiving and retaining the connector therein.

The actuator may be configured as a winch such that the winch may be engaged and disengaged to individual parts of the platform if and when needed. This keeps the winch mechanism simple and easy to use.

The cooperating mount for receiving the connector pin for connecting the winch to a given member may be aligned with a locally reinforced section of the movable or removable member.

In one embodiment, the extendable platform may comprise a guide for guiding the moveable member and/or the removable member along the elongate support member. The guide may include an upper guide member and a lower guide member.

The movable member may provide attachments towards an upper portion of the member for incorporating additional modular sections from the bottom of the movable member. This attachment strategy alleviates the necessity of removing and repositioning each member as height is added to the extendable platform.

In one embodiment, the movable member may have a first end and a second opposing end, the step being mounted toward the first end of the movable member and a female coupling being mounted toward the second end of the movable member.

In one embodiment, the removable member may have a male coupling at a first end thereof. The male coupling may be tapered such that a tip of the male coupling is smaller in cross-sectional area than a base of the male coupling. The removable member may further comprise a female coupling at an opposing end to that of the male coupling for attaching further removable members.

The male coupling at a lower end of the movable member provides a connection point for a removable member. The removable member may include a female coupling at an upper end thereof and a subsequent, identical male coupling at a lower end thereof. In this manner, the removable member can be coupled to the moveable member to provide additional extension range to the extendable platform. Utilising removable sections allows damaged components to be easily replaced, thereby increasing the service life of the extendable platform.

The (female coupling) socket and (male coupling) spigot may be “keyed” by a go-no go feature allowing insertion into upper section in only one orientation. This prevents incorrect assembly of the extendable platform ie. physically preventing insertion of moveable member having the rungs facing the wrong way. The orientation of circular rungs of the moveable member may have minimal effect on the usability of the extendable platform. However, where flat steps or flat rungs are provided their incorrect orientation can introduce dangers for a user, particularly where a top surface of a rung/step is stippled or textured to provide additional grip and an opposing underside is not.

In one embodiment of the invention, at least one of the support member, the movable member and the removable member may comprise a pair of elongate stiles and a plurality of steps mounted between the said stiles. At least one of the support member, the movable member and the removable member may comprise at least one rung mounted between the said stiles.

In another embodiment of the invention, at least one of the support member, the movable member and the removable member may be ladders.

The extendable platform allows access at any height from closed to full length at every increment of rung pitch in between providing an improved range of utility.

When all members of the extendable platform are ladders, the platform is easily accessible once the extendable platform has been extended to the predetermined height. The rungs may be mounted between the stiles of each of the support member, movable member and removable member. At each mounting portion of each stile, the stile may be locally reinforced to provide torsional rigidity to the overall extendable platform.

In another embodiment of the invention, the movable member may further comprise a safety barrier disposed at a predetermined distance from the step.

The safety barrier provides stability and support for a user once supported on the step of the platform at elevated heights.

In another embodiment of the invention, the elongate support member may further comprise an adjustable base.

The adjustable base provides a means of stabilising the support member by spreading the support base and thus stabilising the overall extendable platform. The adjustable base may further provide a levelling mechanism for varying the loading of the extendable platform when disposed on uneven surfaces. The adjustable base, in an open position provides stability when handling the ladder in a vertical position that facilitates easy insertion of the modular sections.

In another embodiment of the invention, the adjustable base may provide adjustable feet. The adjustable feet allow the extendable platform to be levelled before the addition of further extendable platform portions. This provides a safe, sturdy base for erecting the extendable platform from.

In accordance with the present invention there is further provided a method of extending an extendable platform, the method comprising the steps of: (i) engaging an actuator between an elongate support member and a movable member, the movable member having a step mounted thereto; (ii) operating the actuator to move the movable member along the support member thereby moving the step along the support member to position the step at a predetermined distance from the support member; and (iii) locking the movable member in a fixed relationship with the support member independently of the actuator.

An advantage of the invention is that the extendable platform can be positioned in a vertical orientation before the movable member is extended. This facilitates ease of positioning of the extendable platform into the vertical orientation as the extendable platform is in a stowed, compact configuration. Only once the support member is located and stabilised, is the winch mechanism coupled to either of the support member or the moveable member to raise the step to the predetermined height of the work site.

In some embodiments of the invention, the method may further comprise the steps of: (iv) coupling an upper portion of a removable member to a lower portion of the moveable member; (v) disengaging the actuator from the movable member and re-engaging the actuator between the elongate support member and the removable member; (vi) operating the actuator to further vary the position of the step relative to the elongate support member; and (vii) locking the removable member in a fixed relationship with the elongate support.

The members of the extendable platform are added with the support portion in an upright position, so the fully assembled extendable platform does not need to be lifted or erected at full weight.

The individual members of the extendable platform are easily moveable to be assembled in situ, the entire weight of which does not need to be handled as one weight.

The modular configuration of the extendable platform allows a user to purchase, borrow or hire as many member of an extendable platform as required to elevate the step to a predetermined height for a given job.

In accordance with the present invention there is still further provided a method of extending an extendable platform, the method comprising the steps of: (i) vertically orienting an extendable platform, the extendable platform having an elongate support member and a movable member, the movable member having a step mounted thereto; (ii) translating the movable member relative to the support member to position the step at a predetermined distance from the support member; and (iii) retaining the movable member in a fixed relationship with the support member.

In some embodiments, the method may further comprise the steps of: (v) coupling a removable member to a lower portion of the movable member; and (vi) translating both the movable member and the removable member to position the step at a predetermined distance from the support member thereby forming a continuously extendable platform.

In accordance with one form of the present invention there is still further provided an extendable platform system, comprising: an elongate support member; a movable member coupled to the support member to move between a first position and a second position, the moveable member having a step mounted thereto; an engageable retainer coupled to either of the support member or the moveable member; and a winch wherein the movable member is translatable along the support member by the winch to vary the position of the step relative to the support member and the retainer couples the support member to the moveable member to retain the step in fixed relationship with the support member. In some embodiments, the extendable platform system may further comprise at least one removable member, selectively coupleable to at least one of the elongate support member and the moveable member, wherein the removable member is configured to be engageable with the winch to thereby extend the position of the step relative to the support member to a distance greater than a length of the movable member.

Various features, aspects, and advantages of the invention will become more apparent from the following description of embodiments of the invention, along with the accompanying drawings in which like numerals represent like components.

### BRIEF DESCRIPTION OF THE DRAWINGS

Embodiments of the invention will now be described in further detail below, wherein like reference numerals indicate similar parts throughout the several views. Embodiments are illustrated by way of example, and not by way of limitation, with reference to the accompanying drawings, in which:

FIG. 1 is a perspective view of an extendable platform according to one embodiment of the invention;

FIG. 2 is a perspective view of the extendable platform of FIG. 1, in a stowed configuration;

FIG. 3 is a perspective view of the extendable platform of FIG. 1 in a fully extended configuration;

FIG. 4 is a perspective view of a winch mechanism mounted on a support member for selective engagement with a moveable member;

FIG. 5 is a perspective view of a connector for coupling the winch mechanism to the movable member;

FIG. 6 is a perspective view of the connector disengaged from the moveable member, while the moveable member is restrained by a latch;

FIG. 6A is a perspective view of the connector aligned with the moveable member, prior to connection thereto;

FIG. 7 is a perspective view of a male and a female coupling located in the end portions of a pair of stiles;

FIG. 8 is a perspective view of the male and female couplings, once joined to one another;

FIG. 8A is a perspective view of the moveable member connected to the support member, illustrating a retainer supporting a rung of the moveable member;

FIG. 9 is a perspective view of an adjustable base of the support member, illustrating the base in an operative configuration;

FIG. 10 is a perspective view of the adjustable base from FIG. 9, illustrating the base in a storage configuration;

FIG. 11 is a perspective view of a removable member immediately prior to being coupled to the movable member, while the moveable member is supported in a raised position by the support member; and

FIG. 12 is a perspective view of the winch mechanism engaged with the movable member.

### DETAILED DESCRIPTION OF EMBODIMENTS

The invention will now be described more fully hereinafter with reference to the accompanying drawings. The invention may be embodied in many different forms and should not be construed as being limited to the embodiments described below.

While the invention is described herein in relation to an extendable ladder, it is understood that extendable work platforms and similar raised platforms are also contemplated to lie within the disclosure of the invention.

The invention provides an extendable platform 100 for supporting a user thereon, the platform 100 comprising: an elongate support member 10; a movable member moveably 30 coupled to the support member 10 to move between a first position and a second position, the moveable member 30 having a step 1 mounted thereto; and an engageable retainer 5 coupled to either of the support member 10 or the moveable member 30, wherein the movable member 10 is translatable along the support member 10 to vary the position of the step 1 relative to the support member 10 and the retainer 5 couples the support member 10 to the moveable member 30 to retain the step 1 in fixed relationship with the support member 10.

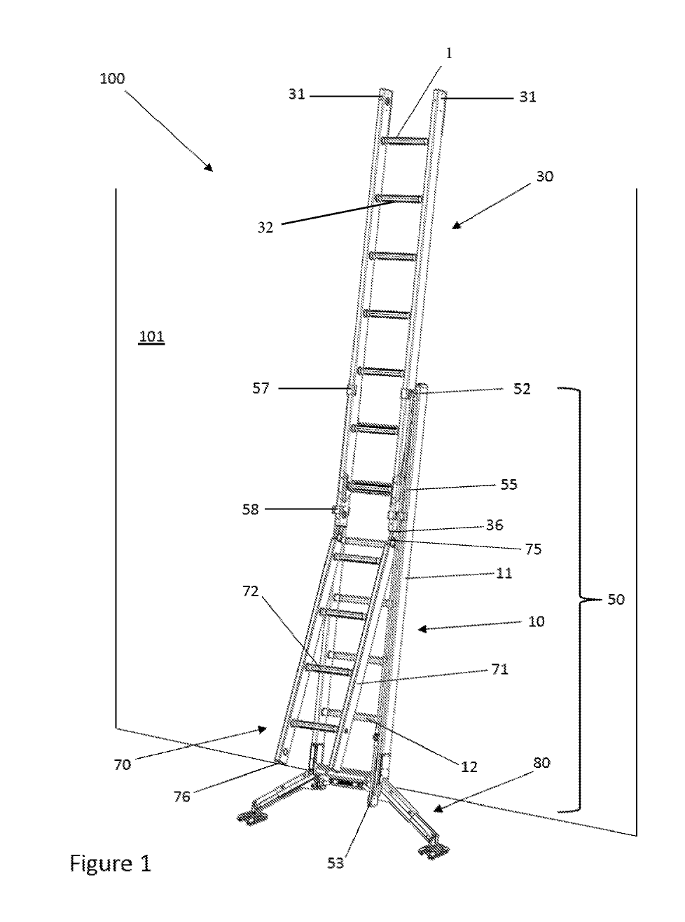

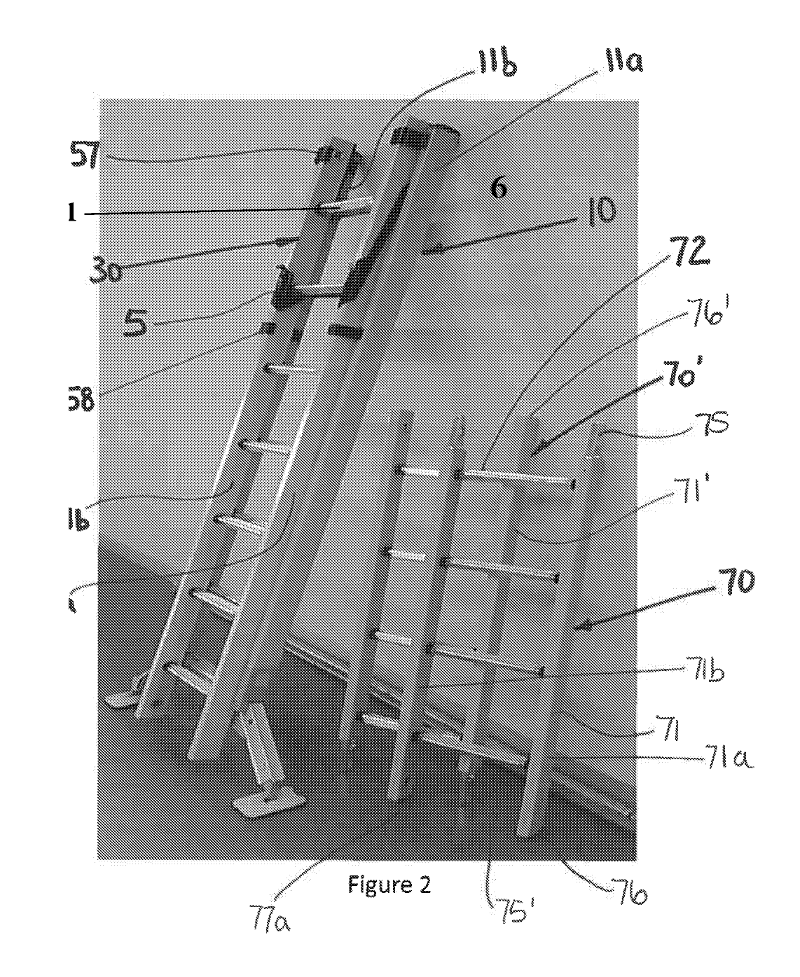

FIGS. 1 and 2 are perspective views of a first embodiment of the invention, where FIG. 1 illustrates the extendable platform 100 in a second extended configuration and FIG. 2 illustrates the extendable platform 100 in a first storage configuration. In this aspect of the invention the support member is illustrated as a base ladder 10 and the movable member is illustrated as a fly-ladder 30, each ladder comprising a pair of stiles 11, 31 and a plurality of steps, illustrated as rungs 12, 32.

Fly-ladder 30 is approximately equal in length to base ladder 10. However, fly-ladder 30 is narrower in width than base ladder 10, such that fly-ladder 30 does not extend, width wise, beyond base ladder 10.

The fly-ladder 30 can be translated along the base ladder 10 by a user manually pushing the fly-ladder 30. Depending on the weight of the fly-ladder 30 this can become physically challenging and pose a risk of user injury. Alternatively, as illustrated in FIG. 1, the extendable platform 100 further comprises an actuator illustrated as a winch 50 permanently affixed to the base ladder 10 and selectively engageable with the fly-ladder 30. It is understood that in some embodiments of the invention the winch 50 can be permanently coupled to the fly-ladder 30 and selectively coupled to the base ladder 10.

Mounting the winch 50 to the base ladder 10 maintains the winch 50 in easy reach of an operator when the extendable platform 100 is extended. Furthermore, this configuration facilitates the addition of a removable member, extension-ladder 70 to further extend the reach of the extendable platform 100. As illustrated in FIG. 1, the extension-ladder 70 is also comprised of a pair of stiles 71 and a plurality of rungs 72.

The extendable platform 100 is transported in its storage configuration in which the base ladder 10 and fly-ladder 30 are substantially aligned with one another in both width and height. The extendable platform 100 is the vertically oriented adjacent a raised work site. The extendable platform 100 once erected is steadied and partially tilted such that an upper portion of the extendable platform 100 rests against a fixed structure in proximity to the work site.

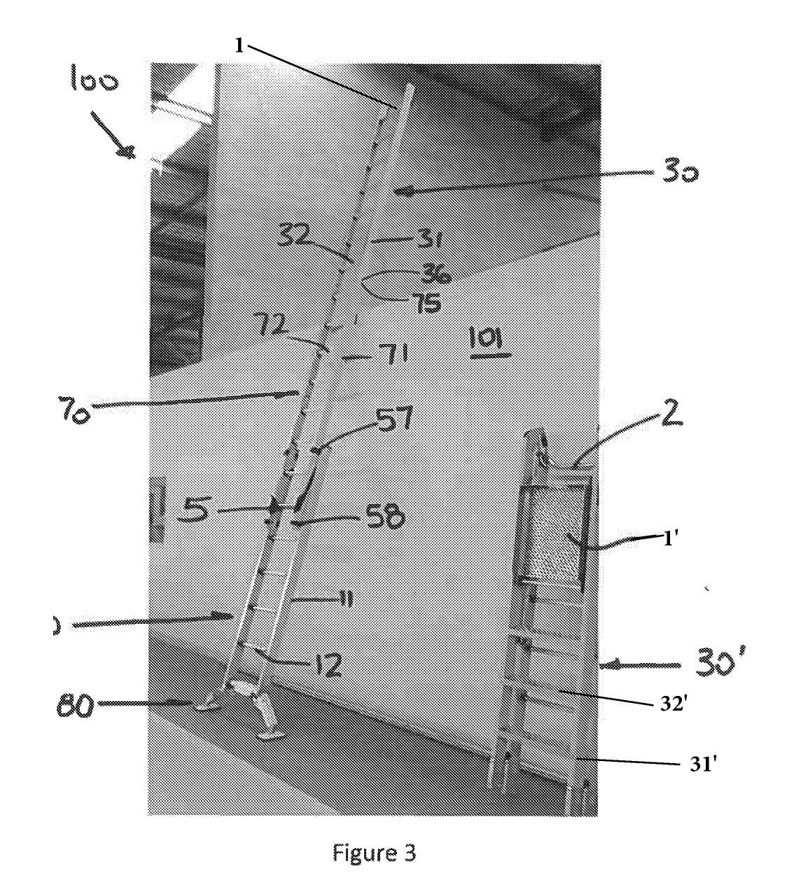

The user can selectively engage the winch 50 to thereby couple the winch 50 to the fly-ladder 30. Operation of the winch 50 then raises the fly-ladder 30 relative to the base ladder 10, and thereby raises the rungs 32 towards the work site. In some embodiments, a single rung or step 1 is provided at the apex of the fly-ladder 30 to provide a work platform for supporting a user. The step 1 can be in the form of a rung (as illustrated in FIG. 1). However, the step 1 can also be in the form of a plate, a podium, a scaffolding or a platform 1′ (as illustrated in FIG. 3). In the embodiment of FIG. 1, a plurality of rungs 32 are provided for ascending the fly-ladder 30 and the upper most rung provides the step 1 for supporting the user at a safe working distance from the work site.

Where the fly-ladder 30 provides insufficient elevation to reach the predetermined worksite, the extension-ladder 70 is coupled to the fly-ladder 30 to provide additional reach. Additional extension-ladders 70′ (not illustrated) can be incorporated into the extendable platform 100 in order to provide sufficient elevation to reach the work site.

In this manner the extendable platform 100 is modular, allowing for the selective coupling of the necessary base ladder 10, fly-ladder 30 and extension-ladder(s) 70 to meet the requirements of a given worksite.

FIG. 3 is a perspective view of the extendable platform of FIG. 1 in a fully extended configuration, having a base ladder 10, fly-ladder 30 and extension-ladder 70 (winch 50 is not visible in FIG. 3).

FIG. 3 further illustrates a platform 1′ configured as a square platform upon which a user is supported as an alternative configuration of step 1. The platform 1′ is mounted upon a fly-ladder 30′. The fly-ladder 30′ has a series of rungs 32′ having a rectangular cross-section approximately the same dimensions as those of the stiles 31′ to which they are attached. The platform 1′ can be pivotally attached to stiles 31′ of fly-ladder 30′ providing a moveable platform 1′ for supporting the user in conjunction with the vertical surface 101 upon which the extendable platform 100 is resting.

FIG. 3 further illustrates a safety barrier 2 disposed at the uppermost extremity of the fly-ladder 30′. The safety barrier 2 is pivotally connected to the fly-ladder 30′ and can be disposed about a body of a user once the user has reached the platform 1′ at an apex of the extendable platform 100. The safety barrier 2 can be used in conjunction with step 1 or platform 1′ when attached to fly-ladder 30 or fly-ladder 30′.

FIG. 3 illustrates the step 1 as an uppermost rung of the fly-ladder 30, wherein step 1 has approximately the same depth as the remaining rungs 32. The rungs 32 and step 1 of fly-ladder 30 all have a circular cross-section or ovoid cross-section. The diameter of each rung 32 is approximately half the depth of the stiles 31.

The winch 50, illustrated in FIG. 1, comprises a pair of pulleys 52, 53 disposed along the base ladder 10. Ideally, the pulleys 52, 53 are disposed at opposing ends of the base ladder 10 to provide maximum adjustment between the length of the extendable platform 100 in the storage configuration and the length of the extendable platform 100 in the extended configuration. As illustrated in FIG. 1, an upper pulley 52 is mounted towards a portion of a stile 11 of the base ladder 10 and a lower pulley 53 is mounted towards a lower portion of the stile 11.

The winch 50 further comprises a cable or cord 55. The cord 55 is configured as a continuous loop, wherein opposing ends of the cord 55 are permanently affixed to a connector 56. The cord 55 must be flexible to loop over the pulleys 52, 53 allowing the connector 56 to move up and down the length of base ladder 10 between the two pulleys. The cord 55 can be a cable, a rope or a chain and can be formed of a plastic material, a metal, natural fibres or a composite material. The dimensions and strength of the cord 55 is determined in response to the weight of the fly-ladder 30 and extension-ladder(s) 70 which the winch 50 is intended to move. The pulleys 52, 53 each provide a concaved circumferential surface upon which to guide the movement of the cord 55 thereover. The concaved surfaces of the pulleys 52, 53 assist in preventing the cord 55 from becoming disconnecting with the pulleys 52, 53 when the cord 55 is moving.

The connector 56 is selectively engageable with fly-ladder 30, and when attached, couples base ladder 10 and fly-ladder 30 via the winch 50. As the cord 55 is pulled downwardly, towards the lower pulley 53, the connector 56 is raised upwardly, towards the upper pulley 52 in turn raising fly-ladder 30 relative to base ladder 10. When the connector 56 approaches the upper pulley 52, the limit of the extension is reached and a detent is employed to prevent the fly-ladder 30 from siding downwards when tension in the cord 55 ceases. The cord 55 can be pulled by hand; alternatively, the pulleys 52, 53 can be connected to a motor to automate the movement of the cord 55 and/or the winch 50.

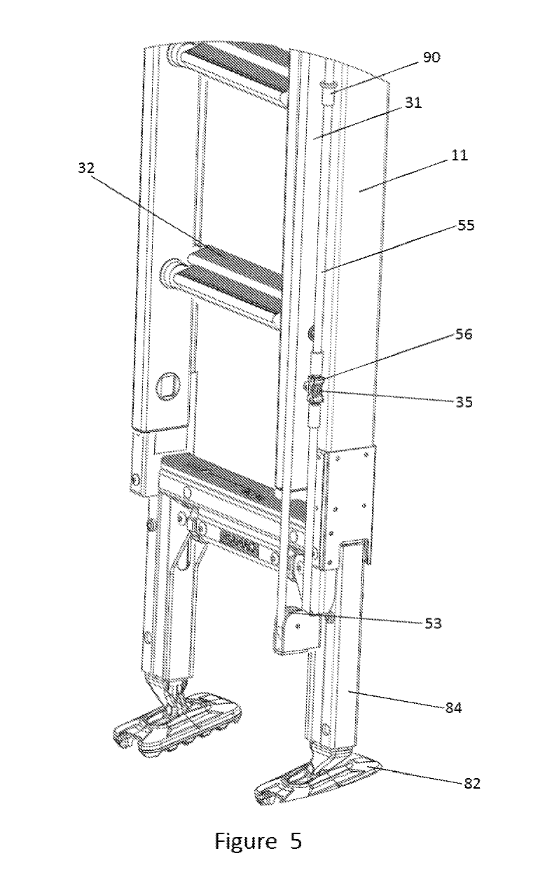

The connector 56 is illustrated in detail in FIG. 5. The connector 56 is a T-shape having a T-bar and a central pin 35 extending therefrom. The central pin 35 is inserted into a receiving aperture 34 of the fly-ladder 30 or aperture 74 of extension-ladder 70.

At least one of each pair of stiles 31, 71 provides a plurality of apertures 34, 74 for receiving and retaining the central pin 35. Preferably, the apertures 34, 74 are disposed at regular intervals along the entire length of each stile 31, 71. The apertures 34, 74 are located on outer surfaces 31a/71a of each stile for ease of access. As illustrated in FIG. 5, it is structurally preferably to locate the apertures 34, 74 in alignment with a rung 32, 72 of fly-ladder 30 or extension-ladder 70, as the stile structure is reinforced by the rungs 32, 72 in these areas. However, the apertures can be located at any position along the length of the stiles 31, 71.

The T-bar of the connector 56 receives a first and a second end of the cord 55 therein and can lie relatively flat along the stile 32 of fly-ladder 30. The connector 56 can be made of metal, allowing the ends of the cord 55 to be crimped thereto; however, other materials like plastic and reinforced polymers can also be used. The central pin 35 of the connector can be integrally formed with the connector 56 or can be glued, screwed or otherwise joined to the T-bar of the connector 56. The diameter of the pin 35 can be selected depending on the material of the pin 35 and loads that the connector 56 will support when the winch 50 is in use. Preferably, the material of the pin 35, and more preferably the entire connector 56 is hardened to be durable and resilient.

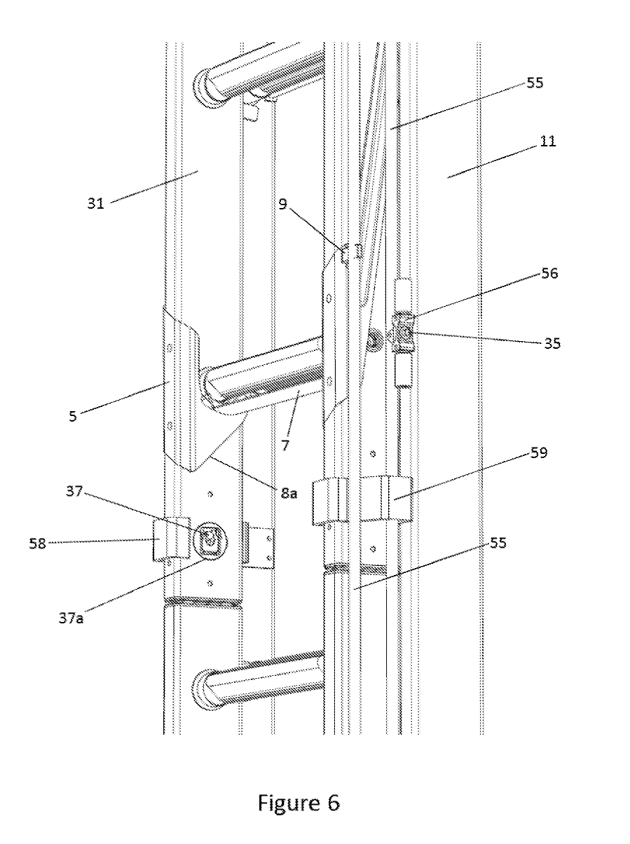

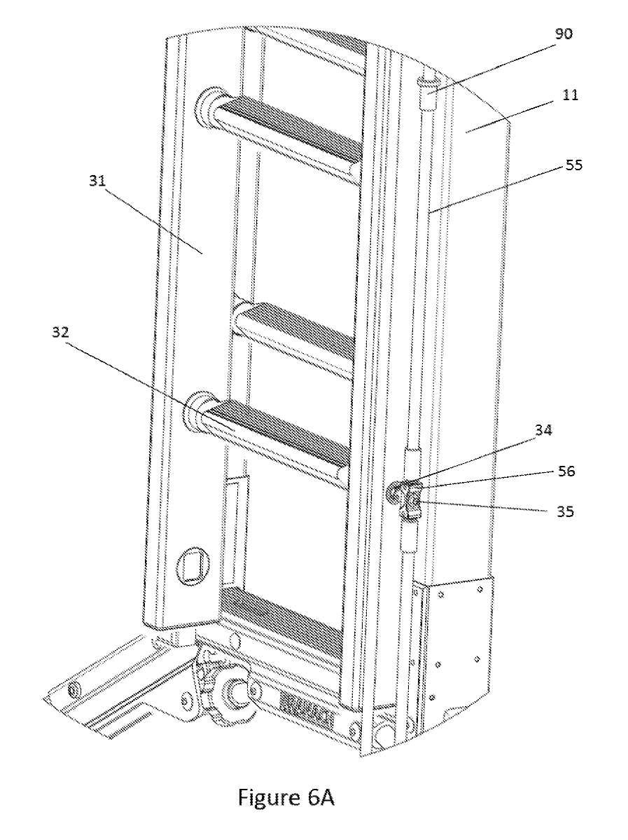

The pin 35 further comprises a retention mechanism illustrated in FIGS. 6 and 6A as a spring-loaded ball. The spring-loaded mechanism is easily inserted and removed from the aperture 34 of stile 31 to attach and removed the connector 56. Other connection mechanisms can also be employed such as snap-fit connectors, twist-lock, keying mechanisms etc. The retention mechanism must be sufficiently strong to connect the base ladder 10 and the fly-ladder 30 via the winch 50 and is ideally connected and released quickly. Preferably the connection can be made and severed with one hand to free a user's other hand to steady the extendable platform 100 where necessary. Once the pin 35 is in position within the aperture 34, there is minimal loading along the length of the pin 35, that is to say that there is minimal load on the pin 35 trying to pull it out of aperture 34. The primary load direction on the pin 35 when the winch 50 is in use places the pin 35 in shear relative to the T-bar of the connector 56.

When the connector 56 is detached from fly-ladder 30 a detent is required to prevent the fly-ladder 30 from siding downwards towards the ladder base 10. The detent frees the users hands as tension on the cord 55 does not need to be maintained, and allows the user to connect extension-ladder 70 if so desired.

The detent is provided in the form of a retainer or latch 5, illustrated in FIGS. 1, 2 and 4. FIG. 2 illustrates the extendable platform 100 with the winch 50 disconnected and thereby provides a clear perspective view of the latch 5. The latch 5 is U-shaped having two free upper ends 6, and a cross-bar 7 connecting the two upper ends 6. The upper ends 6 are pivotally mounted to an upper portion of base ladder 10 and are free to rotate away from base ladder 10 as the fly-ladder 30 is translated along base ladder 10. The free ends 6 are preferably mounted on an inner side 11b of the stiles 11 to keep outer surfaces 11a of the stiles 11 free from protrusions.

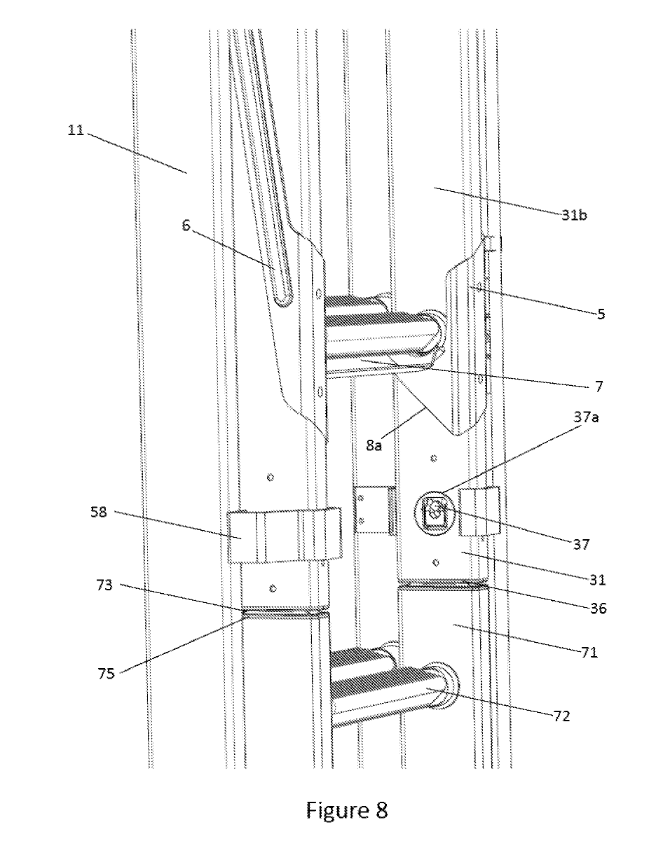

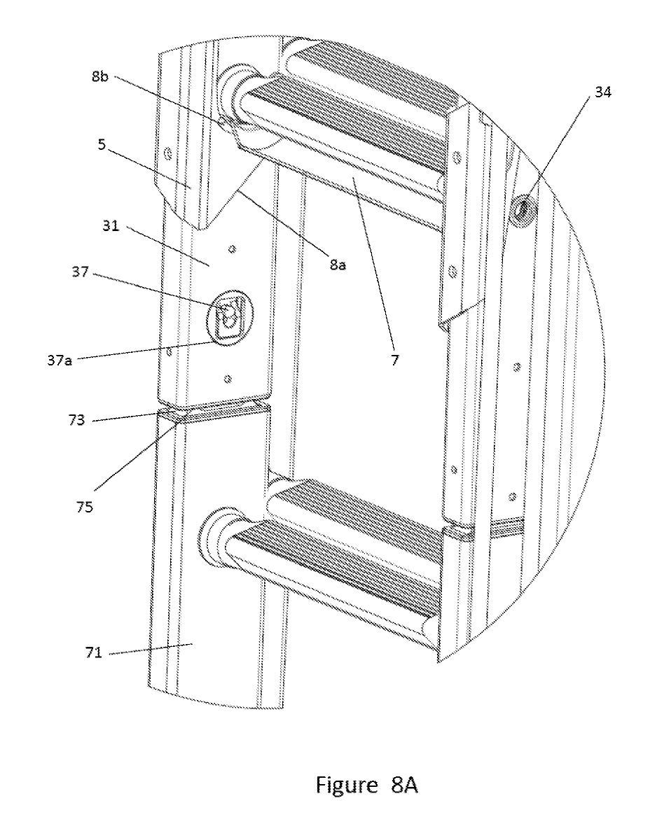

The cross-bar 7 extends across a full width of fly-ladder 30 and is configured to rest directly underneath a rung 32 of the fly-ladder 30 (as illustrated in FIG. 8A). A supporting face 8 of the latch 5 supports a rung 32 thereon when the latch 5 is engaged. Opposing the supporting face 8 is a cam face 8a that urges the cross-bar 7 away from the rung 32 as the fly-ladder 30 is translated away from the base ladder 10.

As a moving rung 32 contacts the cam face 8a of the latch 5, the latch 5 is temporarily slid away from stiles 31 to enable the rung 32 to pass by the latch 5. When the fly-ladder 30 ceases movement away from the base ladder 10, the weight of the latch 5, under gravity, drops the cross-bar 7 of the latch 5 beneath one of the plurality of the rungs 32 of fly-ladder 30 and brings supporting face 8 into contact with the rung 32 thereby securely engaging with the rung 32, preventing fly-ladder 30 from sliding back towards base ladder 10. In this manner the latch 5 operates as a form of ratchet mechanism allowing relative movement of base 10 and fly-ladder 30 in a single direction only.

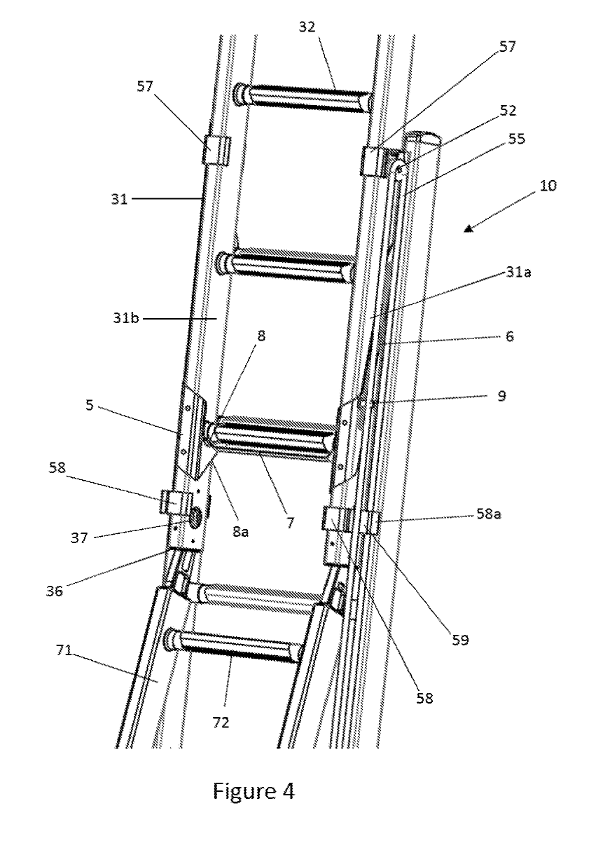

A cable guide is further provided, illustrated as a rope tab 9, to guide the movement of the cable 55, illustrated in FIG. 4. The cable 55 is placed under rope tab 9 as the fly-ladder 30 is lowered downwards, which releases the latch 5 from engagement with a rung 32 of the fly-ladder 30. Configuring the cable 55 and tab 9 in this manner, the latch 5 is prevented from reengaging with a subsequent rung 32 of the fly-ladder 30 by virtue of the tension in the cable 55, while the fly-ladder 30 is descending.

The cable 55 further comprises a stop 90 (illustrated in FIGS. 5, 6A and 9). The stop 90 prevents the cable 55 from being winched past the working limits of the base ladder 10. The stop 90 effectively and simply prevents the fly-ladder 30 from being raised beyond the working range of the base ladder 10, and further prevents the connector 56 from being drawn around the pulleys 52 and 53. The stop 90 can be made from a metal or plastic material. The stop 90 can be permanently affixed to the cable 55, or adjustably affixed along the length of the cable 55 so as to alter the working range of the winch 50.

The winch 50 further comprises a guide for translatable guiding the movement of fly-ladder 30 along base ladder 10. In the embodiments of FIGS. 1 to 4, the guide comprises an upper guide 57 and a lower guide 58. Both guides 57, 58 are permanently affixed to base ladder base 10. Both guides 57 and 58 are configured in a C-shape that can wrap substantially around the stiles 32 of fly-ladder 30, without preventing translation of the stiles 32 through the guides 57, 58.

The lower guide 58 includes an outer wall 58a adjacent to an outer stile surface 31a. The outer wall 58a includes a profile 59 being set-off from the stile surface 31a to allow the connector 56 to pass the lower guide 58 without fouling the guide 58.

The upper guide 57 can be formed with a planar surface for mounting the upper pulley 52 thereto. This minimises the number of components to be attached to the stiles 11, as illustrated in FIG. 4. The upper pulley 52 is mounted to a side portion of the upper guide 57 both of which are mounted to the stile 11. As the connector 56 cannot pass the upper pulley 52, there is no requirement for the upper guide 57 to accommodate the connector 56 in this embodiment. The upper 57 and lower guides 58 are provides on both stiles of base ladder 10 to maintain even loading and stability of the extendable platform 100 while raising fly-ladder 30. However, the winch 50 and therefore the pulleys 52, 53 are only mounted to a single stile 11 of base ladder 10. In some embodiments of the invention, a winch 50 as described above can be coupled to both stiles 11 of the base 10 to reduce the loads on the winch 50.

Returning to FIG. 2, there is illustrated a first extension-ladder 70 and a second extension-ladder 70′ each of which comprise a pair of female couplings 76, 76′ at a lower end of each stile 71, 71′ and a pair of male couplings 75, 75′ at an upper end of each stile 71, 71′. In this manner, any number of extension-ladders 70, 70′can be interconnected to fly-ladder 30. The extension-ladder 70 is the same width as fly-ladder 30 having stiles 71 of similar cross-sectional size.

The female couplings 36 of fly-ladder 30 and male 75 and female 76 couplings of extension-ladder 70 enable the continuous extension of the extendable platform 100 providing a modular form to the extendable platform 100. When the extension-ladder 70 is connected to the fly-ladder 30 the force of gravity will be acting upon the extendable platform 100, thus transferring the weight of fly-ladder 30 downwardly onto extension-ladder 70. As such, the female couplings 36, 76 are configured to be connected above the co-operating male couplings 75, 75′ to increase the loading thereon.

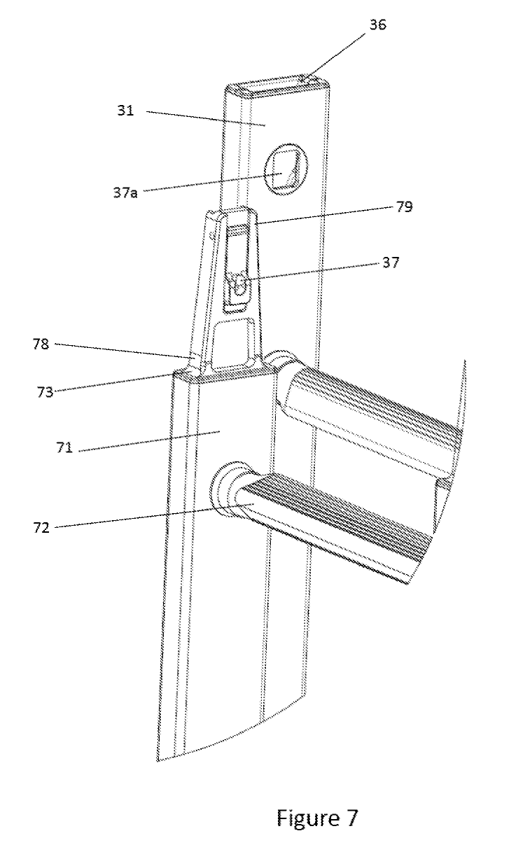

Each male coupling 75, 75′ is upwardly tapered, having a broad base 78 and narrow tip 79, as illustrated in FIG. 7. As the extendable platform 100 is loaded the female couplings 36, 76 are urged downwards along the tapered male couplings 75, 75′, thereby tightening the connection between the male and female couplings. As the extendable platform 100 is frequently assembly and disassembled the couplings will be subject to wear, and thus the taper allows the connection between adjacent male and female couplings to remain snug over years of use.

Towards the base 78 of the male coupling 75 is a shoulder 73 upon which the female coupling rests, illustrated in FIGS. 7 and 8. The mating of the female coupling 36 upon the shoulder 73 provides a tightly tolerance joint that resists movement, keeping fly-ladder 30 and extension-ladder 70 from moving relative to one another.

When a user wants to uncouple the male 75 and female coupling 36, a release 37 is depressed and the fly-ladder 30 and the extension-ladder 70 are released from one another. The release 37 is spring-loaded and is permanently connected to the male coupling 75. The release 37 is accessible to a user through an aperture 37a in the female coupling 36 that can be accessed from the inner stile surface 31b. Similar apertures 77a are provided in the inner stile surfaces 71b of the stiles 71 of extension-ladder 70 for releasing further extension-ladders 70′.

Releasable couplings for ladder sections are discussed in PCT application no. PCT/AU2013/001012 filed by the applicant on 5 Sep. 2013, the disclosure of which is incorporated herein by reference in its entirety.

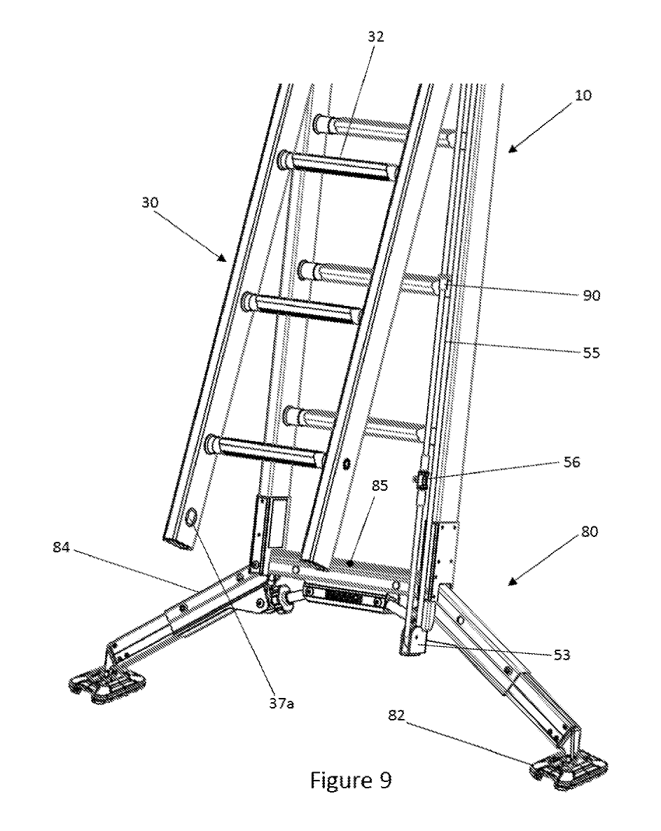

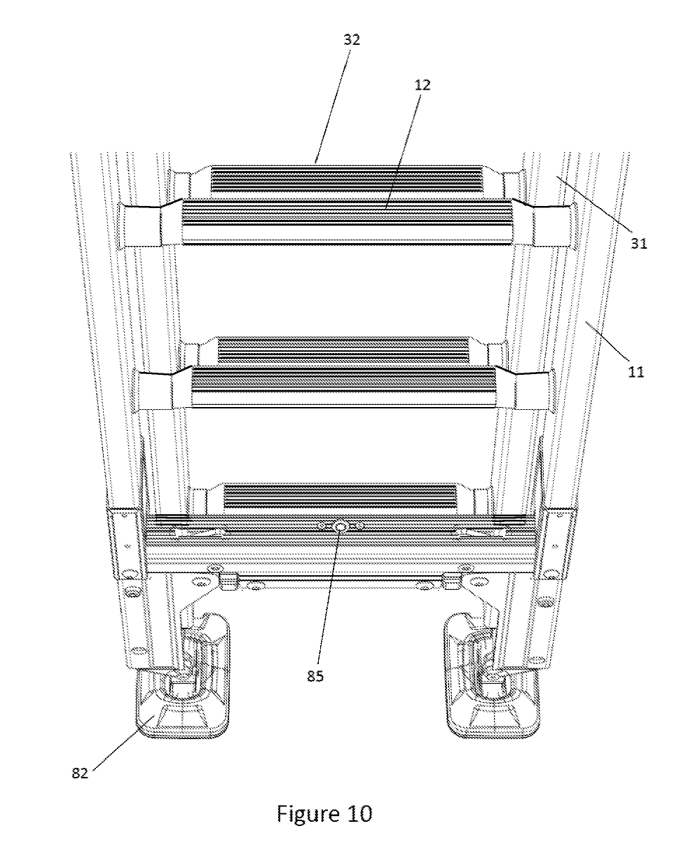

A similar coupling system to that described above can be used to attach an adjustable base member 80 to a lower portion of the base ladder 10. The adjustable base 80 can comprise pivotable feet 82 to stabilise the base ladder 10, movable legs 84 to increase the width of the adjustable base 80 and measurement tools 85 to gauge the inclination of the terrain upon which the extendable platform 100 is supported. An embodiment of the adjustable base 80 is illustrated in FIG. 9, in an extended configuration. FIG. 10, illustrates the adjustable base 80 in a storage configuration, whereby the movable legs 84 are aligned with the stiles 11 of base ladder 10 to streamline the profile of extendable platform 100 for transportation and storage thereof. Figure base 10 further illustrates a spirit level as measurement tool 85 embedded within the adjustable base 80.

Improved ladder levelling stabilisers are discussed in PCT application no. PCT/AU2013/001011 filed by the applicant on 5 Sep. 2013, the disclosure of which is incorporated herein by reference in its entirety.

In a second aspect of the invention, there is provided a method of extending an extendable platform 100, the method comprising the steps of: (i) engaging an actuator illustrated in FIG. 1 as winch 50 between an elongate support member, illustrated as base ladder 10 and a movable member, fly-ladder 30, the fly-ladder 30 having a step 1 mounted thereto; (ii) operating the winch 50 to move the fly-ladder 30 along the base ladder 10 thereby moving the step 1 along the base ladder 10 to position the step 1 at a predetermined distance from the base ladder 10 and (iii) locking the fly-ladder 30 in a fixed relationship with the elongate base ladder 10 independently of the winch 50.

The extendable platform 100 is situated in close proximity to the elevated worksite. The extendable platform 100 is then vertically oriented on the ground and levelled where necessary. The extendable platform 100 can also be tilted towards the work site to rest on a vertical support surface 101. Once the extendable platform 100 is stable and supported, the winch 50 can be used to extend the extendable platform 100.

The connector 56 is initially attached to the fly-ladder 30 at an aperture 34 closest to the lower pulley 53. This will provide the maximum possible extension between the base ladder 10 and fly-ladder 30. The user then pulls downwardly on the cord 55, towards the lower pulley 53, thereby hoisting the fly-ladder 30 upwards and away from the base ladder 10.

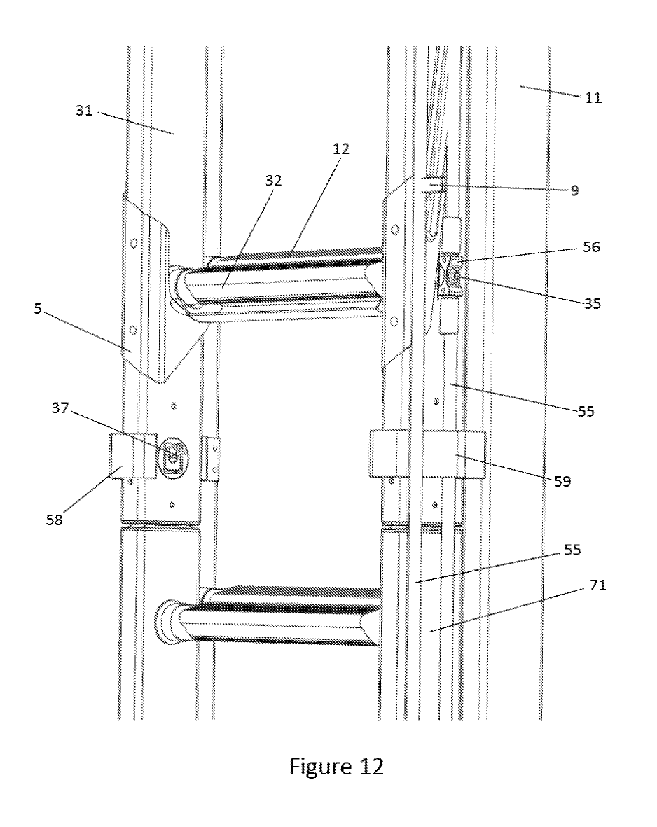

When the fly-ladder 30 has been raised to its full extend i.e. the connector 56 is in proximity to the upper pulley 52, the tension in cord 55 is released and the latch 5 positioned under an adjacent rung 32 of fly-ladder 30, illustrated in FIG. 12. The fly-ladder 30 is then locked in position relative to base ladder 10, independently of the winch 50.

The connector 56 is then released from the aperture 34, as illustrated in FIG. 6, and the cord 55 pulled in a reverse direction to bring the connector 56 back towards the lower pulley 53.

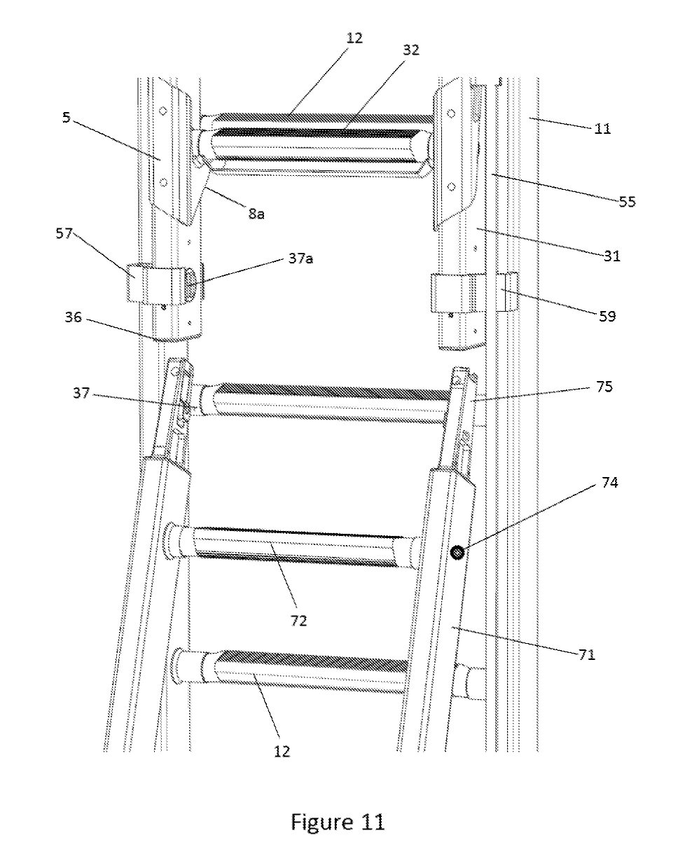

Extension-ladder 70 is positioned to have male couplings 75 in close proximity to the female couplings 36 of fly-ladder 30. The two stiles 31 of fly-ladder 30 and the two stiles 71 of extension-ladder 70 are then aligned and subsequently coupled, illustrated in FIG. 11.

The connector 56 is then engaged with an aperture 74 of extension-ladder 70 closest to the lower pulley 53 to provide maximum extension of the extendable platform 100. The cord 55 is again pulled downwards toward the lower pulley 53 to hoist extension-ladder 70 along and away from base ladder 10. As extension-ladder 70 is pulled upwards away from base ladder 10, the stiles 71 of extension-ladder 70 are threaded into and through the lower 57 and upper guides 58.

When a desired extension is reached i.e. the step 1 of fly-ladder 30 is adjacent the work site, the latch 5 is engaged to ensure that neither fly-ladder 30 nor extension-ladder 70 can move relative to base ladder 10.

The stiles of base ladder 10, fly-ladder 30 and extension-ladder 70 can be made from numerous materials, steel, aluminium, reinforced plastics, composites and fibreglass. The choice of material is a balance between, weight, strength and cost and can be varied on the size and application of the particular extendable platform 100 to be fabricated. As the stiles are primarily constant sections, extrusion or rolled sections are particularly favoured manufacturing means. Each of the ladders 10, 30 and 70 can be constructed of stiles made from the same materials. Alternatively, the base ladder 10 can be made from a heavier and/or stronger material to provide a more structural support for the subsequent ladder sections. Furthermore, the extension-ladder section(s) 70 can be made from lighter weight materials to minimise the additional weight to be supported by the base ladder 10 and fly-ladder 30.

While the stiles 11, 31 and 71 are illustrated herein as rectangular sections, it is contemplated that square, circular or ovoid cross-sectional stiles can also be used for each or any of base ladder 10, fly-ladder 30 and extension-ladder 70.

This method of constructing and extending extendable platform 100 allows the user to connect and raise each of fly-ladder 30, extension-ladder 70 and additional extension-ladders extension-ladder 70′ one at a time. Accordingly, the weight of the extendable platform 100 increases but only once the base ladder 10 is firmly in place adjacent the vertical support surface 101 and proximate the worksite to be accessed. The extendable platform 100 does not require connections into the vertical surface 101 and can be extended piece by piece until the desired elevation of step 1 is achieved. Each of the section is sized and weighted to be handled and lifted by a single user without undue strain and thereby reduce the opportunities for personal injury. Furthermore, the individual components of the extendable platform 100 can be easily transported by a vehicle and carried to work sites with limited access, to be erected in situ.

In a third aspect of the invention, there is provided a method of extending an extendable platform, the method comprising the steps of: (i) vertically orienting the extendable platform 100, the extendable platform 100 having an elongate support member, illustrated in FIG. 1 as a base ladder 10, and a movable member, illustrated as fly-ladder 30, the fly-ladder 30 having a step 1 mounted thereto; (ii) translating the movable fly-ladder 30 relative to the base ladder 10 to position the step 1 at a predetermined distance from the base ladder 10; and (iii) retaining the fly-ladder 30 in a fixed relationship with the base ladder 10.

In this aspect of the invention, the extendable platform 100 is vertically raised adjacent the work site to be accessed and the fly-ladder 30 is manually raised while being translated along the base ladder 10. Once the fly-ladder 30 has reached the limit of its extension along base ladder 10, a removable member, extension-ladder 70 is coupled to a lower portion of the fly-ladder 30 to enable the step 1 to be further elevated while supported by the base ladder 10. In this manner a continuously extendable platform 100 is created. Each new portion added to the extendable platform 100 is lifted and fitted individually to the extendable platform 100 so the weight of the entire extendable platform 100 is borne by the base ladder 10 and not a user.

It will be appreciated by persons skilled in the art that numerous variations and modifications may be made to the above-described embodiments, without departing from the scope of the following claims. The present embodiments are, therefore, to be considered in all respects as illustrative and not restrictive.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### LEGEND

| | |
|---|---|
| 101 | Vertical support surface |
| 100 | Extendable platform |
| 1 | Step |
| 1′ | Platform |
| 5 | Latch |
| 6 | Upper free ends |
| 7 | Cross bar |
| 8 | Rung support |
| 8a | Cam surface |
| 9 | Rope tab |
| 10 | Support member |
| 11 | Stile |
| 11a | Outer stile surface |
| 11b | inner stile surface |
| 12 | rung |
| 30 | Movable member |
| 30′ | Alternative movable member |
| 31 | Stile |
| 31a | Outer stile surface |
| 31b | Inner stile surface |
| 32 | Rung |
| 34 | Aperture |
| 35 | Pin |
| 36 | Female coupling |
| 37 | Coupling release |
| 37a | Coupling release hole |
| 50 | Winch mechanism |
| 52 | Upper pulley |
| 53 | Lower pulley |
| 55 | Cord |
| 56 | Connector |
| 57 | Upper guide |
| 58 | Lower guide |
| 58a | Outer wall of lower guide |
| 59 | Profile |
| 70 | Removable member |
| 71 | Stile |
| 71a | Outer stile surface |
| 71b | Inner stile surface |
| 72 | Rung |
| 73 | Shoulder |
| 74 | Aperture |
| 75 | Male coupling |
| 76 | Female coupling |
| 78 | Connector base |
| 79 | Connector tip |
| 80 | Adjustable base |
| 82 | Feet |
| 84 | Legs |
| 85 | Inclination gauge |
| 90 | Cable stop |

1. An extendable platform for supporting a user thereon, the platform comprising:
an elongate support member;
a movable member coupled to the support member to move between a first position and a second position, the moveable member having a step mounted thereto; and
an engageable retainer coupled to either of the support member or the moveable member,
wherein the movable member is translatable along the support member to vary the position of the step relative to the support member and the retainer couples the support member to the moveable member to retain the step in fixed relationship with the support member.

2. The extendable platform according to claim 1, further comprising an actuator mounted to either of the support member or the movable member.

3. The extendable platform according to claim 2, wherein operation of the actuator moves the moveable member along the elongate support member to vary the position of the step relative to the elongate support member.

4. The extendable platform according to claim 2, wherein the actuator is selectively engageable between the elongate support member and the moveable member.

5. The extendable platform according to claim 1, wherein the retainer allows relative movement between the support member and the movable member in a first direction and resists movement in a second, opposing direction.

6. The extendable platform according to claim 1, wherein the movable member has a first end and a second opposing end, the step being mounted toward the first end of the movable member and a female coupling being mounted toward the second end.

7. The extendable platform according to claim 1, further comprising a removable member having a male coupling at a first end thereof and a second female coupling at a second end thereof, wherein the male coupling of the removable member is received by the female coupling of the movable member to thereby couple the removable member to the movable member.

8. The extendable platform according to claim 7, wherein the actuator is selectively engageable with the removable member, such that operation of the actuator moves the removable member and the moveable member simultaneously and thereby varies the position of the step relative to the elongate support member.

9. (canceled)

10. The extendable platform according to claim 2, wherein the actuator comprises a pair of pulleys and a chord, the chord extending over each of the pulleys to define a continuous loop thereover.

11. The extendable platform according to claim 10, the actuator further comprising a connector permanently attached to the chord.

12. The extendable platform according to claim 11, wherein the connector is selectively engageable with a cooperating mount on the removable member and at least one of the elongate support member and the moveable member.

13. The extendable platform according to claim 12, wherein the cooperating mount is an aperture for receiving and retaining the connector therein.

14. The extendable platform according to claim 11, wherein the connector is a pin having a releasable detent.

15. The extendable platform according to claim 1, wherein the platform comprises a guide for guiding the moveable member and/or the removable member along the elongate support member.

16. (canceled)

17. The extendable platform according to claim 7, wherein at least one of the support member, the movable member and the removable member comprises a pair of elongate stiles and at least one rung mounted between the said stiles.

18. (canceled)

19. The extendable platform according to claim 7, wherein at least one of the support member, the movable member and the removable member are ladders.

20-21. (canceled)

22. A method of extending an extendable platform, the method comprising the steps of:
(i) engaging an actuator between an elongate support member and a movable member, the movable member having a step mounted thereto;
(ii) operating the actuator to move the movable member along the support member thereby moving the step along the support member to position the step at a predetermined distance from the support member; and
(iii) locking the movable member in a fixed relationship with the support member independently of the actuator.

23. The method of claim 22, further comprising the steps of:
(iv) coupling an upper portion of a removable member to a lower portion of the moveable member;
(v) disengaging the actuator from the movable member and re-engaging the actuator between the elongate support member and the removable member;
(vi) operating the actuator to further vary the position of the step relative to the elongate support member; and
(vii) locking the removable member in a fixed relationship with the elongate support.

24-25. (canceled)

26. An extendable platform system, comprising:
an elongate support member;
a movable member coupled to the support member to move between a first position and a second position, the moveable member having a step mounted thereto;
an engageable retainer coupled to either of the support member or the moveable member; and
a winch,
wherein the movable member is translatable along the support member by the winch to vary the position of the step relative to the support member and the retainer couples the support member to the moveable member to retain the step in fixed relationship with the support member.

27. The extendable platform system of claim 26, further comprising:
at least one removable member, selectively coupleable to at least one of the elongate support member and the moveable member,
wherein the removable member is configured to be engageable with the winch to thereby extend the position of the step relative to the support member to a distance greater than a length of the movable member.
